(19) United States
(12) Patent Application Publication
(10) Pub. No.: US 2011/0014935 A1
(43) Pub. Date: Jan. 20, 2011

(54) APPARATUS AND METHOD FOR SCHEDULING SENSING CHANNEL IN WIRELESS COMMUNICATION SYSTEM

(75) Inventors: Changhyun PARK, Daejeon (KR); Myung Sun SONG, Daejeon (KR); Sang-Won KIM, Daejeon (KR); Sunmin LIM, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/639,170

(22) Filed: Dec. 16, 2009

(30) Foreign Application Priority Data
Jul. 16, 2009 (KR) 10-2009-0064883

(51) Int. Cl. H04B 7/005

(52) U.S. Cl. 455/509

(57) ABSTRACT

Provided is an apparatus and method for scheduling a sensing channel in a wireless communication system. The sensing channel scheduling apparatus may include: an evaluation value calculator to calculate evaluation values with respect to a channel quality for each of channels; a sorter to sort the evaluation values based on a predetermined criterion; and a scheduler to perform scheduling for sequences of the channels using sequences of the sorted evaluation values.

### CROSS-REFERENCE TO RELATED APPLICATION

This application claims the benefit of Korean Patent Application No. 10-2009-0064883, filed on Jul. 16, 2009, in the Korean Intellectual Property Office, the disclosure of which is incorporated herein by reference.

### BACKGROUND

1. Field of the Invention

Embodiments of the present invention relate to an apparatus and method for scheduling a sensing channel in a wireless communication system, and more particularly, to an apparatus and method for scheduling a sensing channel in a wireless communication system using an evaluation value with respect to a channel quality.

2. Description of the Related Art

In a wireless communication system, securing channels may become an important issue to perform a stable data communication. Specifically, in the wireless communication, there is a need to sense channels suitable for a channel change before a channel change event occurs due to various types of wireless communication environments.

Accordingly, there is a need for an apparatus and method for scheduling a sensing channel that may perform scheduling for sequences of sensing channels based on a quality and a characteristic of each channel.

### SUMMARY

An aspect of the present invention provides an apparatus and method for scheduling a sensing channel that may calculate an evaluation value with respect to a channel quality, using at least one of a channel identifier (ID), a channel set classification, an incumbent user (IU) appearance rate, a distance between the corresponding channel and an occupied channel that is located at a shortest distance, and a channel idle time, and may perform scheduling using the evaluation value, so that channels may be effectively used.

According to an aspect of the present invention, there is provided an apparatus for scheduling a sensing channel in a wireless communication system, the apparatus including: an evaluation value calculator to calculate evaluation values with respect to a channel quality for each of channels; a sorter to sort the evaluation values based on a predetermined criterion; and a scheduler to perform scheduling for sequences of the channels using sequences of the sorted evaluation values.

According to another aspect of the present invention, there is provided a method of scheduling a sensing channel in a wireless communication system, the method including: calculating evaluation values with respect to a channel quality for each of channels; sorting the evaluation values based on a predetermined criterion; and performing scheduling for sequences of the channels using sequences of the sorted evaluation values.

### EFFECT

According to embodiments of the present invention, there may be provided an apparatus and method for scheduling a sensing channel in a wireless communication system that may calculate an evaluation value with respect to a channel quality, using at least one of a channel identifier (ID), a channel set classification, an incumbent user (IU) appearance rate, a distance between the corresponding channel and an occupied channel that is located at a shortest distance, and a channel idle time, and may perform scheduling using the evaluation value, so that channels may be effectively used.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of an apparatus for scheduling a sensing channel in a wireless communication system according to an embodiment of the present invention;

FIG. 2 is a flowchart illustrating a method of scheduling a sensing channel in a wireless communication system according to an embodiment of the present invention; and

FIG. 3 is a diagram for describing an example of scheduling a sensing channel in a wireless communication system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, an apparatus and method for scheduling a sensing channel in a wireless communication system according to an embodiment of the present invention will be described with reference to the accompanying drawings.

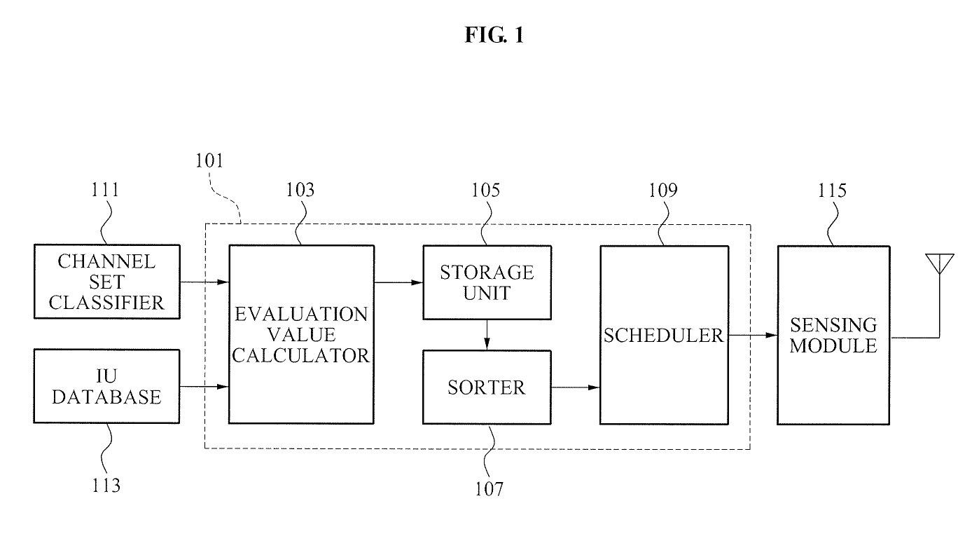

FIG. 1 is a block diagram illustrating a configuration of an apparatus 101 for scheduling a sensing channel in a wireless communication system according to an embodiment of the present invention. The configuration of the sensing channel scheduling apparatus 101 and peripheral devices in the wireless communication system will be described with reference to FIG. 1.

Referring to FIG. 1, the sensing channel scheduling apparatus 101 may include an evaluation value calculator 103, a storage unit 105, a sorter 107, and a scheduler 109. Depending on embodiments, the sorter 107 may be included in the scheduler 109. Another method of comparing evaluation values with respect to a channel quality may also be employed.

The evaluation value calculator 103 may calculate evaluation values with respect to a channel quality for each of channels. The evaluation value calculator 103 may calculate an evaluation value of a corresponding channel using at least one of a channel identifier (ID), a channel set classification, an incumbent user (IU) appearance rate, a distance between the corresponding channel and an occupied channel that is located at a shortest distance, and a channel idle time.

For example, the evaluation value calculator 103 may calculate a first evaluation value I(c) to be greater as a channel ID c is lower. The first evaluation value I(c) may be expressed by the following Equation 1:

$$I ( c ) = - \frac{1}{N - n} c + \frac{N}{N - n} . \qquad [ Equation 1 ]$$

Here, N denotes a MAX channel ID, n denotes a MIN channel ID, and c denotes a current channel ID.

The evaluation value calculator 103 may receive a channel set classification of the channel from a channel set classifier 111, and calculate a second evaluation value S(c) using the channel set classification. For example, the evaluation value calculator 103 may calculate the second evaluation value S(c) to be greater in an order of a backup channel set classification, a candidate channel set classification, and an occupied channel set classification. The second evaluation value S(c) may be expressed by the following Equation 2:

$$S ( c ) = \{ \begin{matrix}1 ( c is backup ) , \\ 0.75 ( c is candidate ) , \\ 0 ( c is occupied ) .\end{matrix} \qquad [ Equation 2 ]$$

When information associated with the channel set classification does not exist, the evaluation value calculator 103 may calculate the second evaluation value S(c) to be greater in an order of an empty channel and an occupied channel.

The evaluation value calculator 103 may receive the IU appearance rate from an IU database 113. As the IU appearance rate is lower, the evaluation value calculator 103 may calculate a third evaluation value tan⁻¹A(c) to be greater. For example, the third evaluation value tan⁻¹A(c) may be expressed by the following Equation 3:

$${tan}^{- 1} A ( c ) = {tan}^{- 1} \frac{no of Appearance}{total no of sensing} . \qquad [ Equation 3 ]$$

When the distance between the channel and the occupied channel positioned at the shortest distance exceeds a predetermined threshold, the evaluation value calculator 103 may calculate a fourth evaluation value E(c) as an assignable maximum evaluation value. As the distance between the channel and the occupied channel located at the shortest distance increases, the evaluation value calculator 103 may calculate the fourth evaluation value E(c) to be greater. For example, the fourth evaluation value E(c) may be expressed by the following Equation 4:

$$E ( c ) = \{ \begin{matrix}1 ( if {Dist}_{c - omin} \geq Threshold ) , \\ 0 ( if {Dist}_{c - omin} \leq 1 ) , \\ 0.5 ( if 1 < {Dist}_{c - omin} \leq 3 ) , \\ 0.7 ( otherwise ) .\end{matrix} \qquad [ Equation 4 ]$$

The evaluation value calculator 103 may calculate a final evaluation value R(c) through a sum of the first through the fourth evaluation values I(c), S(c), tan⁻¹A(c), and E(c). In this instance, the evaluation value calculator 103 may calculate the final evaluation value R(c) by assigning first through fourth weights w₁, w₂, w₃, and w₄ to the first through the fourth evaluation values I(c), S(c), tan⁻¹A(c), and E(c), respectively. The final evaluation value R(c) may be expressed by the following equation 5:

R(c)=w₁·I(c)+w₂·S(c)+w₃·tan⁻¹(A(c))+w₄·E(c). [Equation 5]

When a value obtained by subtracting a sum of a time elapsed after a previous sensing is performed t and a sensing processing time tp from a sensing demand time D(c) of the channel is less than or equal to a predetermined threshold, the evaluation value calculator 103 may calculate the evaluation value of the channel as a maximum evaluation value regardless of the first through the fourth evaluation values I(c), S(c), tan⁻¹A(c), and E(c), which may be expressed by the following Equation 6:

D(c)−t−tₚ≦γ. [Equation 6]

Here, D(c) denotes the sensing demand time of the channel, and may be, for example, 2 seconds, 6 seconds, or 10 seconds. The sensing demand time D(c) may vary depending on an inband that is operating through a sensing module 115, and an outband that is not operating through the sensing module 115.

As described above, t denotes the time elapsed after a previous sensing is performed, and tp denotes the sensing processing time and may be, for example, 120 milliseconds. r may denote a random positive number.

Every time the evaluation value calculator 103 calculates an evaluation value with respect to a channel quality, the calculated evaluation value may be stored in the storage unit 105 for each channel ID.

The sorter 107 may sort evaluation values based on a predetermined criterion. For example, the sorter 107 may sort the evaluation values in an ascending order or in a descending order.

The scheduler 109 may perform scheduling for sequences of the channels using the sorted evaluation values. For example, when the evaluation values are sorted in an order from a maximum value to a minimum value, the scheduler 109 may perform scheduling for the sequences of the channels in an order of channels corresponding to the sorted evaluation values. Specifically, the scheduler 109 may perform scheduling for a channel corresponding to a greater evaluation value in a priority order so that channels with a relatively excellent channel quality may be scheduled.

The sensing module 115 may receive a scheduled channel and a sensing operation time from the scheduler 109, and may verify a type of a signal that is received via an antenna using the scheduled channel and the sensing operation time. Also, the sensing module 115 may verify where the signal exists using a signal classification algorithm.

In the wireless communication system, a sensing channel scheduling scheme may include a preemptive scheduling scheme and a non-preemptive scheduling scheme. In the case of the preemptive scheduling scheme, a priority order may be dynamically changed for each sensing performed and channel sensing may be performed in an order of a channel having a higher priority order. In the case of the non-preemptive scheduling scheme, channel sensing may be performed in a determined channel order. In comparison to the preemptive scheduling scheme, the non-preemptive scheduling scheme may decrease overhead.

According to an embodiment of the present invention, in a wireless communication system, a sensing channel scheduling apparatus may support a non-preemptive scheduling scheme. Accordingly, a sequence scheduled for every scheduling period may be fixed until a subsequent scheduling is performed.

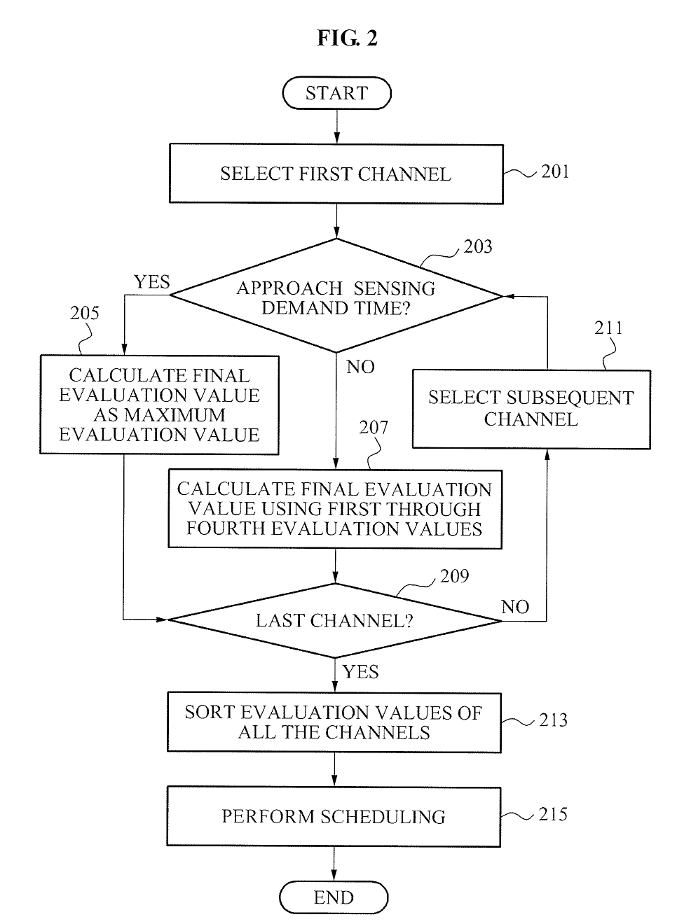

Hereinafter, a method of scheduling a sensing channel in a wireless communication system according to an embodiment of the present invention will be described with reference to FIG. 2. FIG. 2 is a flowchart illustrating a method of scheduling a sensing channel in a wireless communication system according to an embodiment of the present invention. Here, evaluation values with respect to a channel quality may be calculated for each channel. Sequences of channels may be scheduled in an order of a greater evaluation value.

Referring to FIG. 2, in operation 201, a sensing channel scheduling apparatus may select a first channel.

For example, the sensing channel scheduling apparatus may select one channel to calculate an evaluation value of the channel with respect to a channel quality.

In operation 203, the sensing channel scheduling apparatus may determine whether a sensing idle time of the channel approaches a sensing demand time.

Here, the sensing idle time of the channel indicates a presently elapsed time after a final sensing is performed for the channel.

For example, the sensing channel scheduling apparatus may determine whether a value obtained by subtracting a sum of a time elapsed after a previous sensing is performed t and a sensing processing time tp from a sensing demand time D(c) of the selected channel is less than or equal to a predetermined threshold.

In operation 205, when the sensing idle time approaches the sensing demand time, the sensing channel scheduling apparatus may calculate a final evaluation value of the selected channel as a maximum evaluation value.

For example, when the value obtained by subtracting the sum of the time elapsed after a previous sensing is performed t and the sensing processing time tp from the sensing demand time D(c) of the selected channel is less than or equal to the predetermined threshold, the sensing channel scheduling apparatus may calculate the final evaluation value of the selected channel as the maximum evaluation value.

Conversely, when the sensing idle time does not approach the sensing demand time, the sensing channel scheduling apparatus may calculate the final evaluation value using first through fourth evaluation values in operation 207.

For example, when the value obtained by subtracting the sum of the time elapsed after a previous sensing is performed t and the sensing processing time tp from the sensing demand time D(c) of the selected channel is greater than the predetermined threshold, the sensing channel scheduling apparatus may calculate the final evaluation value using the first through the fourth evaluation values.

Specifically, the sensing channel scheduling apparatus may calculate the final evaluation value using a sum of a first evaluation I(c) using a channel ID, a second evaluation S(C) using a channel classification set, a third evaluation value tan⁻¹A(c) using an IC appearance rate, and a fourth evaluation value E(c) using a distance between a corresponding channel and an occupied channel located at a shortest distance. In this instance, the sensing channel scheduling apparatus may calculate the final evaluation value by assigning first through fourth weights w₁, w₂, w₃, and w₄ to the first through the fourth evaluation values I(c), S(c), tan⁻¹A(c), and E(c), respectively.

For example, the sensing channel scheduling apparatus may calculate the first evaluation value I(c) to be greater as the channel ID c is lower. The sensing channel scheduling apparatus may calculate the second evaluation value S(c) to be greater in an order of a backup channel set classification, a candidate channel set classification, and an occupied channel set classification. The sensing channel scheduling apparatus may calculate the third evaluation value tan⁻¹A(c) to be greater as the IU appearance rate is lower. As the distance between the channel and the occupied channel located at the shortest distance becomes farther, the evaluation value calculator 103 may calculate the fourth evaluation value E(c) to be greater.

In operation 209, the sensing channel scheduling apparatus may verify whether the selected channel is a last channel.

Specifically, the sensing channel scheduling apparatus may verify whether the selected channel is the last channel among target channels, and verify whether evaluation values of all the channels are calculated.

When the selected channel is not the last channel, the sensing channel scheduling apparatus may select a subsequent channel in operation 211, and repeat operations 203 through 209.

Conversely, when the selected channel is the last channel, the sensing channel scheduling apparatus may sort the evaluation values of all the channels based on the predetermined criterion in operation 213. In operation 215, the sensing channel scheduling apparatus may perform scheduling for sequences of the channels using the sorted evaluation values.

Specifically, when the evaluation values are sorted in an order from a maximum value to a minimum value, the sensing channel scheduling apparatus may perform scheduling for the sequences of the channel in an order of channels corresponding to the sorted evaluation values.

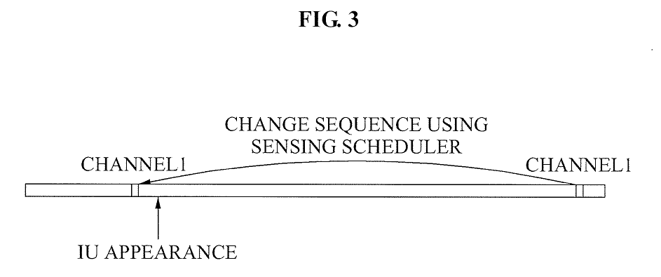

Hereinafter, sensing channel scheduling effects in a wireless communication system according to an embodiment of the present invention will be described in detail with reference to FIG. 3. FIG. 3 is a diagram for describing an example of scheduling a sensing channel in a wireless communication system according to an embodiment of the present invention.

Referring to FIG. 3, in the wireless communication system, when an evaluation value of channel 1 among scheduled channels is relatively high, the sensing channel scheduling apparatus may locate, in a front portion, channel 1 that has been positioned in a rear portion. Accordingly, before scheduling is performed, channel 1 may not be sensed at a point in time of an IU appearance and thus may not be included in a higher order in a backup channel list. However, after the scheduling is performed, a probability that channel 1 may be sensed before the point in time of the IU appearance may increase. Accordingly, it may be more probable that channel 1 may be included in the higher order of the backup channel list.

In the case of an inband, sensing may need to be performed within 2 seconds. In the case of an outband, the sensing may need to be performed within 6 seconds. In the case of the inband, a number of target channels may be one through three. Accordingly, even when sequences of channels are changed, a sensing time difference may be insignificant. However, in the case of the outband, a number of target channels may be about 30. Accordingly, when sequences of channels are changed, a time of about 4 seconds with respect to the sensing time difference may result.

As described above, according to an embodiment of the present invention, a sensing channel scheduling apparatus in a wireless communication system may perform scheduling for channels to optimize sensing sequences of the channels. Accordingly, in comparison to a case where the channels are not scheduled, it is possible to stably obtain channels.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for scheduling a sensing channel in a wireless communication system, the apparatus comprising:
an evaluation value calculator to calculate evaluation values with respect to a channel quality for each of channels;
a sorter to sort the evaluation values based on a predetermined criterion; and
a scheduler to perform scheduling for sequences of the channels using sequences of the sorted evaluation values.

2. The apparatus of claim 1, wherein the evaluation value calculator calculates an evaluation value of a corresponding channel using at least one of a channel identifier (ID), a channel set classification, an incumbent user (IU) appearance rate, a distance between the corresponding channel and an occupied channel that is located at a shortest distance, and a channel idle time.

3. The apparatus of claim 2, wherein the evaluation value calculator calculates the evaluation value to be greater, as the channel ID is lower, in an order of a backup channel set classification, a candidate channel set classification, and an occupied channel set classification, and as the distance between the corresponding channel and the occupied channel that is located at the shortest distance becomes greater.

4. The apparatus of claim 2, wherein, when a value obtained by subtracting a sum of a time elapsed after a previous sensing is performed and a sensing processing time from a sensing demand time of the channel is less than or equal to a predetermined threshold, the evaluation value calculator calculates the evaluation value of the channel as a maximum evaluation value.

5. The apparatus of claim 2, wherein the evaluation value calculator calculates the evaluation value of the channel by assigning a weight to each of the channel ID, the channel set classification, the IU appearance rate, and the distance between the corresponding channel and the occupied channel that is located at the shorted distance.

6. The apparatus of claim 1, wherein, when the evaluation values are sorted in an order from a maximum value to a minimum value, the scheduler performs scheduling for the sequences of the channels in an order of channels corresponding to the sorted evaluation values.

7. A method of scheduling a sensing channel in a wireless communication system, the method comprising:
calculating evaluation values with respect to a channel quality for each of channels;
sorting the evaluation values based on a predetermined criterion; and
performing scheduling for sequences of the channels using sequences of the sorted evaluation values.

8. The method of claim 7, wherein the calculating calculates an evaluation value of a corresponding channel using at least one of a channel ID, a channel set classification, an IU appearance rate, a distance between the corresponding channel and an occupied channel that is located at a shortest distance, and a channel idle time.

9. The method of claim 8, wherein the calculating calculates the evaluation value to be greater, as the channel ID is lower, in an order of a backup channel set classification, a candidate channel set classification, and an occupied channel set classification, and as the distance between the corresponding channel and the occupied channel that is located at the shortest distance becomes greater.

10. The method of claim 8, wherein, when a value obtained by subtracting a sum of a time elapsed after a previous sensing is performed and a sensing processing time from a sensing demand time of the channel is less than or equal to a predetermined threshold, the calculating calculates the evaluation value of the channel as a maximum evaluation value.

11. The method of claim 8, wherein the calculating calculates the evaluation value of the channel by assigning a weight to each of the channel ID, the channel set classification, the IU appearance rate, and the distance between the corresponding channel and the occupied channel that is located at the shorted distance.

12. The method of claim 7, wherein, when the evaluation values are sorted in an order from a maximum value to a minimum value, the performing scheduling performs scheduling for the sequences of the channels in an order of channels corresponding to the sorted evaluation values.
